(19) United States
(12) Patent Application Publication
(10) Pub. No.: US 2012/0196055 A1
(43) Pub. Date: Aug. 2, 2012

(54) PRESENTATION TOOL FOR DISPLAY OF AESTHETIC QUALITIES

(75) Inventors: Todd Andrew WOOD, Toronto (CA); Joseph Michael HOFER, Kitchener (CA); Fredrik HERMANN, Ystad (SE)

(73) Assignee: RESEARCH IN MOTION LIMITED, Waterloo (CA)

(21) Appl. No.: 13/015,033

(22) Filed: Jan. 27, 2011

(51) Int. Cl. F16B 5/07

(52) U.S. Cl. 428/33

(57) ABSTRACT

A presentational tool is described. The presentation tool enables presentation of aesthetic qualities alone or in combination. The presentation tool comprises a base and one or more presentation elements (which include one or more aesthetic qualities) that can be detachably connected to the base.

### TECHNICAL FIELD

The present disclosure relates generally to devices for demonstrating, displaying and comparing combinations of aesthetic qualities such as colours, surface textures and materials.

### BACKGROUND

There are many examples of products that can have one or more colours, surface textures, materials, and other aesthetic qualities. A buyer of a product may desire to see an arrangement of aesthetic qualities before making a purchase of the product.

### BRIEF DESCRIPTION OF THE DRAWINGS

FIG. 1 is a perspective view of a presentational tool.

FIG. 2 is different perspective view of a presentational tool.

FIG. 3 is an overhead plan view of a presentation tool.

FIG. 4 is an underside plan view of a presentation tool.

FIG. 5 is a side view of a presentational tool.

FIG. 6 is a different side view of a presentational tool.

FIG. 7 is a cross-sectional view of a presentation tool.

FIG. 8A is an overhead perspective view of a typical presentation element.

FIG. 8A is an underside perspective view of the typical presentation element.

FIG. 9 is an underside perspective view of a presentational tool with presentation elements attached.

FIG. 10 is an underside perspective view of a presentational tool with some presentation elements attached and one presentational element detached.

FIG. 11 is an underside perspective view of a presentational tool with some presentation elements attached and one presentational element further detached.

FIG. 12 is an overhead perspective view of two nested presentational tools.

FIG. 13 is an underside perspective view of two nested presentational tools.

FIG. 14 is an overhead plan view of two nested presentational tools.

FIG. 15 is an underside plan view of two nested presentational tools.

FIG. 16 is a cross-sectional view of two nested presentational tools and one presentational tool that is not nested.

FIG. 17 is an overhead plan view of a presentational tool with presentation elements having illustrative aesthetic qualities.

FIG. 18 is an overhead perspective view of a presentational tool presentation elements having illustrative aesthetic qualities.

FIG. 19 is an overhead perspective view of a presentational tool with tool with some presentation elements attached and one presentational element detached.

FIG. 20 is an overhead perspective view of a presentational tool with tool with several presentation elements detached.

### DETAILED DESCRIPTION

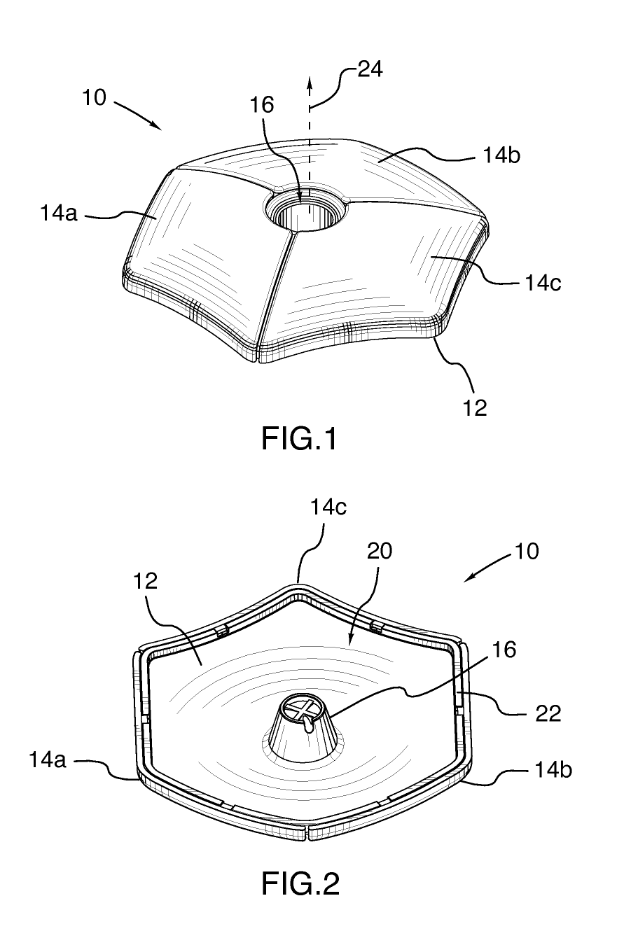

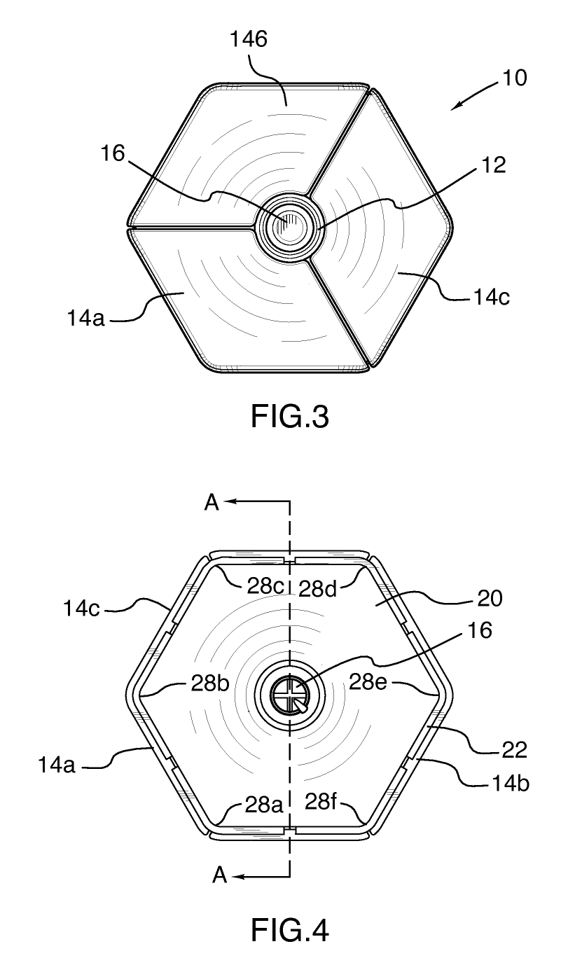

FIG. 1 is a perspective view of a presentational tool 10 for presentation of aesthetic qualities alone or in combination. FIG. 1 represents a typical view of the presentation tool 10 as it would be seen in ordinary usage. FIG. 2 is a perspective view of the presentational tool 10 shown in FIG. 1. In contrast to the top view provided in FIG. 1, FIG. 2 provides an underside view of the presentational tool 10. In ordinary usage and presentation, the presentational tool 10 may be held in a hand or placed on a table, and the underside view of FIG. 2 would not be seen. FIG. 3 represents an overhead plan view of the presentation tool 10.

In an illustrative employment, presentational tool 10 may be useful to buyers and sellers of products, when the products have one or more aesthetic qualities. “Aesthetic qualities” include, but are not limited to colours, surface textures, materials, finishes, coatings, designs, ornaments, trademarks, logos, engravings, pictures, holographic elements, surface features, thicknesses, creases, indentations, ridges, edgings, and combinations thereof “Aesthetic qualities” are not necessarily limited to qualities that can be seen. For example, features such as texture or softness, which may be best assessed by touch, may also be deemed “aesthetic qualities.” As used herein, “aesthetic qualities” may include not only qualities that are purely decorative but may include qualities that are functional as well as decorative. For example, metallic trim may provide a pleasant appearance to a product, but it may also provide structural integrity, protection or desirable electrical characteristics. Even if the presentational tool 10 includes none of the actual functionality (for example, the presentational tool 10 might not have any electrical components), the presentational tool 10 may be useful to buyers and sellers who wish to assess the appearance of the metallic trim, while recognizing that in a finished product the trim may have aesthetic and functional qualities.

As will be discussed below, presentational tool 10 enables people like buyers and sellers to observe and assess the aesthetic qualities alone or in combination, and readily to change one or more of the displayed aesthetic qualities. A buyer of the product may desire to see an arrangement of aesthetic qualities before making a purchase of the product. For example, the buyer may want to get an idea about what a product will look like if it were to have one part having one particular colour and texture, and another part having a different colour and texture. Presentation tool 10 enables the seller to demonstrate, and the buyer to consider, several combinations of aesthetic qualities without the seller actually having to undergo the expense of manufacturing a completed product having any combination of those aesthetic qualities. Presentation tool 10 further enables the buyer to specify a desired combination of aesthetic qualities, and the seller can order the manufacture of products having the aesthetic qualities specified by the buyer.

Presentation tool 10 includes a base 12 and at least one presentation element 14. In the embodiment shown in FIGS. 1-3, presentation tool 10 includes three presentation elements 14a, 14b and 14c. The concept described herein is not limited to three presentation elements 14, however, and may include any number of presentation elements 14.

As shown in FIGS. 1-3 (and as illustrated in other figures), the presentation elements 14 are detachably connected to the base 12. That is, the presentation elements 14 can be attached to and detached from the base 12. When attached to the base 12, the presentation elements 14 and the base 12 behave as a single unit. In other words, when the presentation elements 14 are attached to the base 12, the presentation tool 10 can be turned, inverted, and otherwise manipulated without the presentation elements 14 detaching accidentally from the base 12. As will be described below, one embodiment enables the presentation elements 14 to be attached and detached manually without a need for any tools.

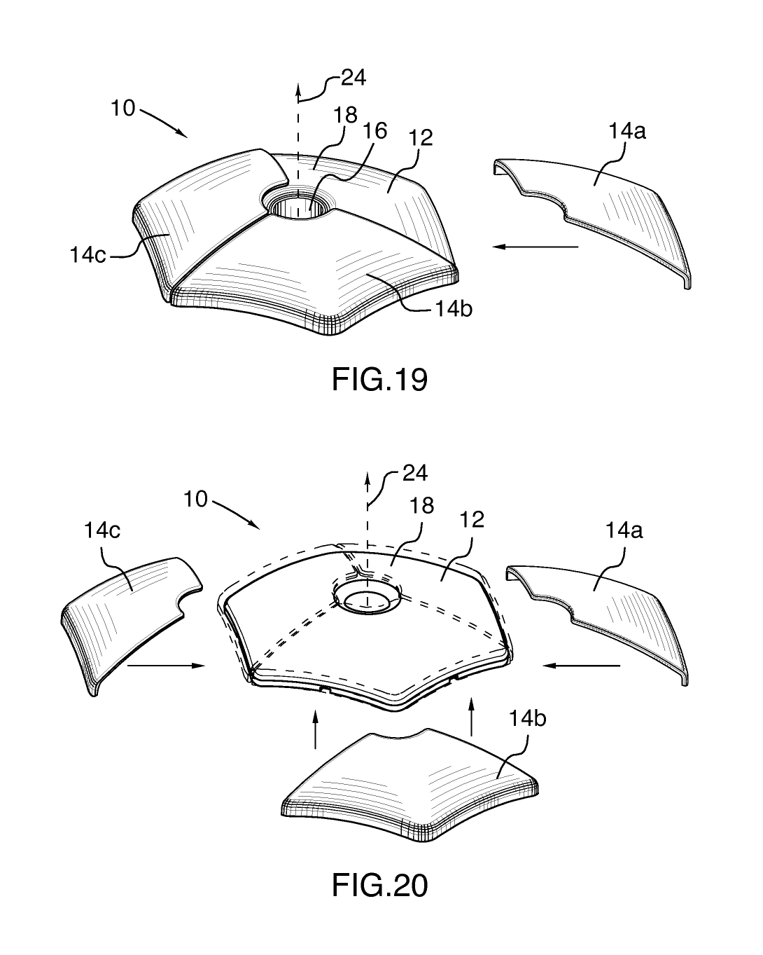

In the embodiment of the presentation element 10 shown in FIGS. 1-3 (and in other figures), the base 12 includes a central well 16, a top side 18 (see FIGS. 19 and 20) and an underside 20. When the presentation elements 14 are connected to the base 12, the presentation elements 14 typically cover at least a portion of the top side 18. In general, the top side 18 represents the side of the presentation tool 10 where the aesthetic qualities are displayed. In FIGS. 1 and 3, the top side 18 is barely visible. The top side 18 might be glimpsed at the central well 16 and through the gaps between the presentation elements 14, for example, but a significant portion of the top side 18 is hidden from view by the attached presentation elements 14.

FIG. 2 shows an outer edge 22 of the base 12. The well 16 is located at approximately the center of the perimeter of the outer edge 22. In this embodiment of the presentation tool 10, the outer edge 22 is not generally visible in FIG. 1 or 3, because the outer edge 22 is totally or almost totally obscured by the attached presentation elements 14. The outer edge 22 may be substantially planar, such that the presentation tool 10 may rest stably on a planar surface such as a table. For purposes of description, a reference axis 24 is shown in FIG. 1. The reference axis 24 is perpendicular to the plane defined by the outer edge 22, and runs through the center of the well 16. As will be discussed below, the entire outer edge 22 may be, but need not be, planar.

As shown in FIGS. 1 and 2, presentation tool 10 has a bowed shape that bulges toward the top side 18 (in the direction indicated by the reference axis 24). In other words, when placed upon a planar surface such as a table with the outer edge 22 resting substantially flush on the planar surface, the top side 18 bulges upward and away from the planar surface. The shape of the bulge of the presentation tool 10, excluding the well 16, may be any shape, including but not limited to spherical (or spheroid) cap. From a view along the reference axis 24, the well 16 may appear circular, as shown in FIGS. 1 and 3. As shown in FIG. 2, the three-dimensional shape of the well 16 may be substantially or partly a circular frustum, but the well 16 may be any other shape. The well 16 may serve several functions, such as enabling stacking (or nesting) of multiple presentation tools 10, improving ease of detachment of presentation elements 14, and enabling the presentation of the aesthetic qualities.

The presentation elements 14a, 14b and 14c are deployed radially away the well 16. Viewed from above, as in FIG. 3, the presentation tool 10 may have a radial symmetry. As shown in FIG. 3, the presentation tool 10 may appear substantially as a regular hexagon when viewed from above, but the concepts described herein are not limited to a regular hexagonal shape. A variation of the presentation tool 10 may appear to be substantially octagonal when viewed from above, for example (and such a variation may include, for example, four presentation elements 14 instead of three). A further variation of the presentation tool 10 may appear to be substantially circular when viewed from above. The concept described herein is not limited to any particular shape.

The approximate diameter of the presentation tool 10, measured through the well 16 and measured from side to side, can be between ten to twenty centimeters, for example. The height of the presentation tool 10 may be three to ten centimeters, for example. The concepts described herein are not limited to any particular dimension or range of sizes, however. In general, it can be advantageous to make presentation tool 10 large enough that it can be easily seen and examined, yet compact enough that it can be readily packed in a briefcase or carried and held in a hand.

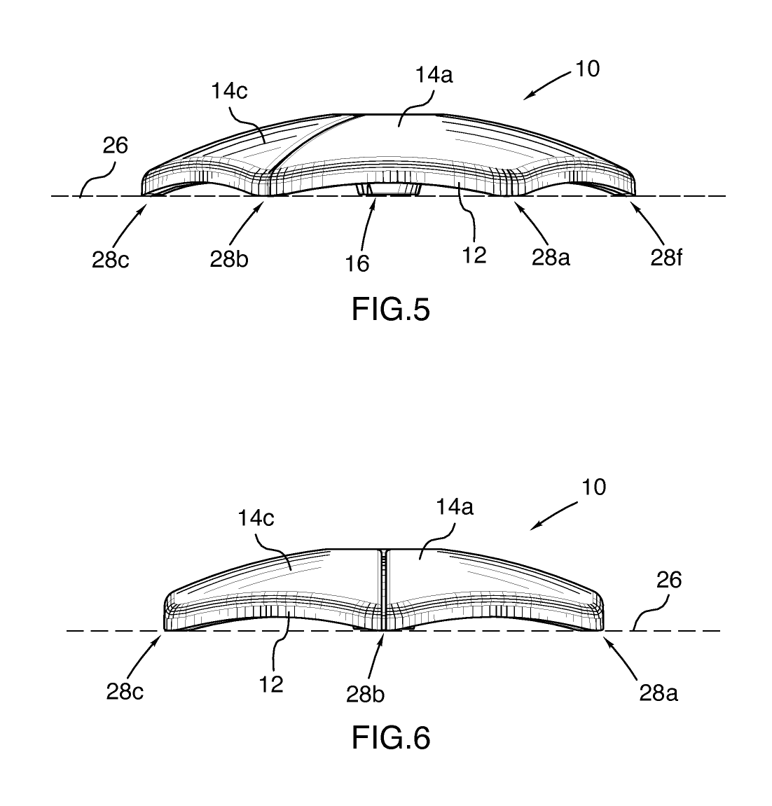

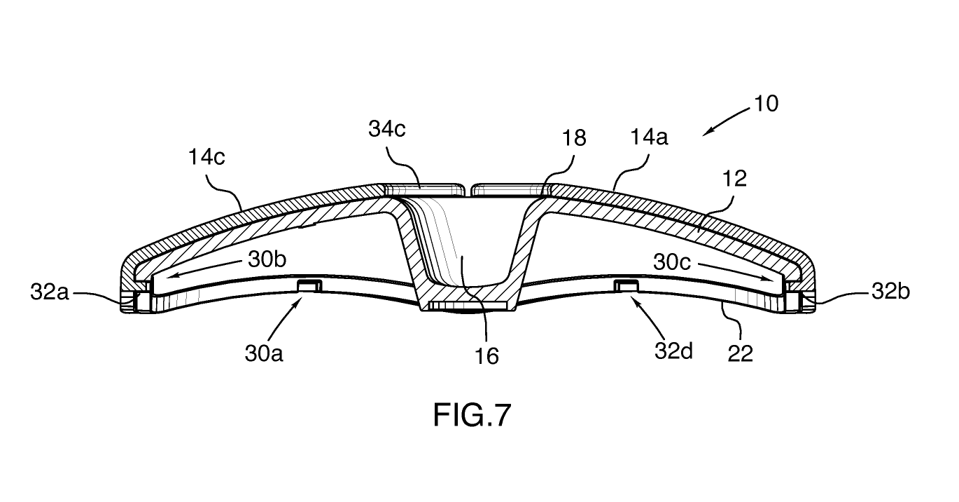

FIG. 4 represents an underside plan view of the presentation tool 10. FIGS. 5 and 6 are side views of the presentation tool 10. FIG. 7 is a cross-sectional view of the presentation tool 10 as cut by plane A-A (shown in FIG. 4) along the reference axis 24. FIGS. 5 and 6 show the edge of a reference plane 26 that is orthogonal to the reference axis 24.

As illustrated in FIGS. 5-7, the entire outer edge 22 need not be planar. In the embodiment depicted in FIGS. 5-7, the outer edge 22 of the base 12 includes six corners or vertices 28a-f and the vertices 28a-f form a substantially regular hexagon. As shown by FIGS. 5 and six, vertices 28 lie substantially along the reference plane 26 (i.e., the vertices 28a-f are substantially coplanar) such that the presentation tool 10 may rest stably on a planar surface. Between the vertices 28, the outer edge 22 may bow upward. This bowing upward may make the presentation tool 10 more aesthetically pleasing, and may also enable a user to more easily pick up the presentation tool 10 from a planar surface. The bowing upward may also enable neater stacking or nesting of multiple presentation tools 10, as described below. The bottom of the well 16 may, but need not, be in substantially the same plane 26 as vertices 28.

The cross-sectional view of FIG. 7 shows further detail of the presentation tool 10. The base 12 may be, but need not be, a solid one-piece construction. The base 12 may be constructed from any material or combination of materials, including metal or plastic. In a typical implementation, the base 12 may be formed from molded plastic. In a variation, the base 12 may be molded of plastic but may include a metal plug on the bottom of the well 16 for stability and improving ease of handling. Each presentation element 14 likewise may be may be, but need not be, a solid one-piece construction, and may be constructed from any material or combination of materials, including metal or plastic. When attached to the base 12 as (as shown in FIG. 7), the presentation elements 14 may abut snugly to the top side 18 of the base 12.

FIG. 7 further shows engagement mechanisms that may be configured to detachably connect one or more presentation elements 14 to the base 12. In general, the engagement mechanisms are configured to detachably connect a presentation element 14 to the base 12 when the engagement mechanisms mate or otherwise engage such that the presentation element 14 is substantially securely coupled to the base 12. When the engagement elements are so connected, the presentation element 14 and the base 12 behave as a single unit, and the presentation element 14 will not detach from the base 12 without the application of force to cause the detachment. In a typical implementation, an application of force by a user can cause a presentation element 14 to detach from the base 12 without damage to either the presentation element 14 or the base 12.

Although the concepts described herein are not limited to the particular engagement elements, the figures show illustrative engagement elements. The base 12 includes one or more base engagements 30 and the presentation elements 14 include one or more presentation element engagements 32 that mate to the base engagements 30. When the presentation element engagements 32 of a presentation element 14 mate to the base engagements 30, the presentation element 14 is securely attached to the base 12 such that presentation element 14 and the base 12 behave as a single unit. The presentation element engagements 32 and the base engagements 30 are configured, however, so that the mating can be readily undone, and the presentation element 14 can be detached from the base 12, without the need for tools. In other words, the presentation element engagements 32 of a presentation element 14 may be readily disengaged from the base engagements 30, such that the presentation element 14 is no longer securely attached to the base 12.

The mating attachment mechanism depicted in FIG. 7 is a notch-protrusion mechanism. The base 12 includes one or more notches 30. In the cross-sectional view of FIG. 7, four notches 30a-d are shown. Notches 30a and 30d are shown in a perspective view, and notches 30b and 30c are shown in cross-section. In the embodiment of presentation tool 10 which appears substantially hexagonal when viewed from above, there may be one notch 30 near the midpoint of each of the six sides.

Presentation elements 14 include one or more protrusions or tenons 32 sized and shaped to engage the notches 30. As shown in FIG. 7, protrusion 32a is engaged with notch 30b, and protrusion 32b is engaged with notch 30c. The engagement causes presentation elements 14 to be detachable connected to the base 12. In the embodiment of presentation tool 10 which appears substantially hexagonal when viewed from above and that can have three presentation elements 14, each presentation element 14 may include two protrusions 32 that engage to the respective notches 30 near the midpoint of the sides of the base 12.

Although the concept described herein is not limited to the notch-protrusion mechanism described above, the notch-protrusion mechanism may realize one or more advantages. Notches and protrusions can provide a secure fit for materials of many types. Consequently, a single base 12 constructed of plastic may mate with a presentation element 14 made of metal and another presentation element 14 made of silicone. In the embodiment of the presentation tool 10 depicted in FIGS. 1-7, each presentation element engagement 32 mates with two corresponding base engagements 30, resulting in a more secure engagement. Even though the engagement is secure, the presentation elements 14 may be detached manually without a need for any tools. A user may, for example, insert a finger into the well 16 and apply force to an inner edge 34 of a presentation element 14, thereby popping the protrusions 32 from the notches 30 and thereby disengaging or detaching the presentation element 14 from the base 12. The base 12 or the presentation element 14 or both typically have enough flexibility to allow the base engagement 30 and the presentation element engagement 32 to readily engage and disengage from one another. Further, notches and protrusions are easy to form, have no moving parts, and are durable.

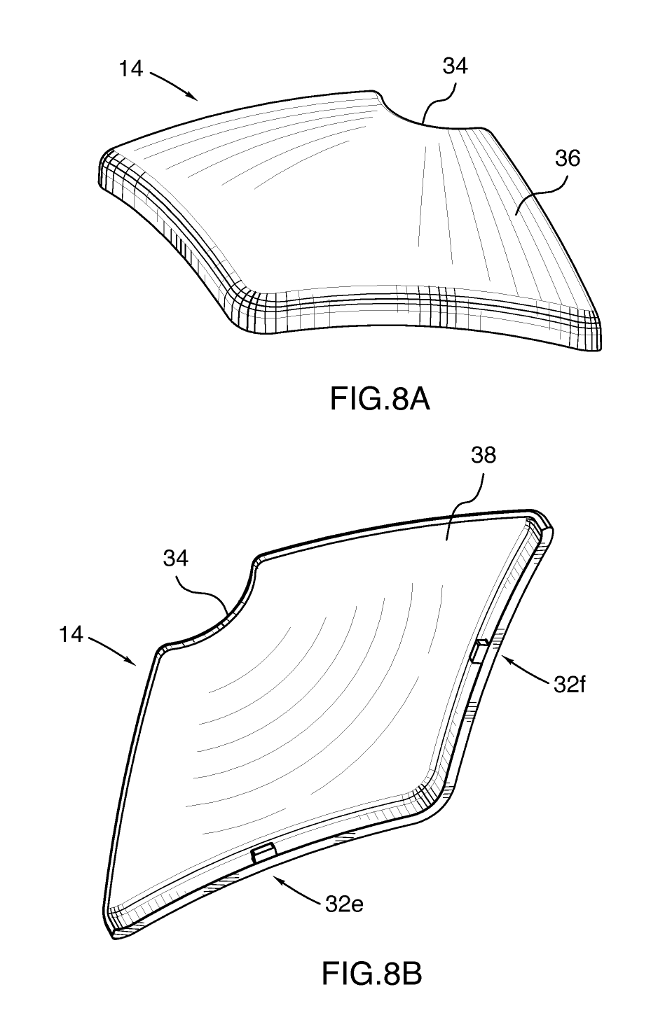

FIGS. 8A and 8B provide perspective views of a typical presentation element 14. In FIG. 8A, the top side 36 of the presentation element 14 is shown and in FIG. 8B, the underside 38 of the presentation element 14 is shown. In FIG. 8B, two presentation element engagements, represented as protrusions 32e and 32f, are depicted. The protrusions 32e and 32f are configured to detachably mate with notches near the outer edge 22 of a base 12.

The top side 36 of the presentation element 14 typically includes one or more aesthetic qualities. In other words, when the presentation element 14 is connected to the base 12, the underside 38 of the presentation element 14 is hidden, as it is proximate to the top side 18 of the base 12, but the top side 36 of the presentation element 14 is exposed. As a result, the aesthetic qualities included on the top side 36 of the presentation element 14 are exposed. Although depicted as a smooth surface, the top side 36 of the presentation element 14 may also have physical features such as a crease or a groove or other physical feature.

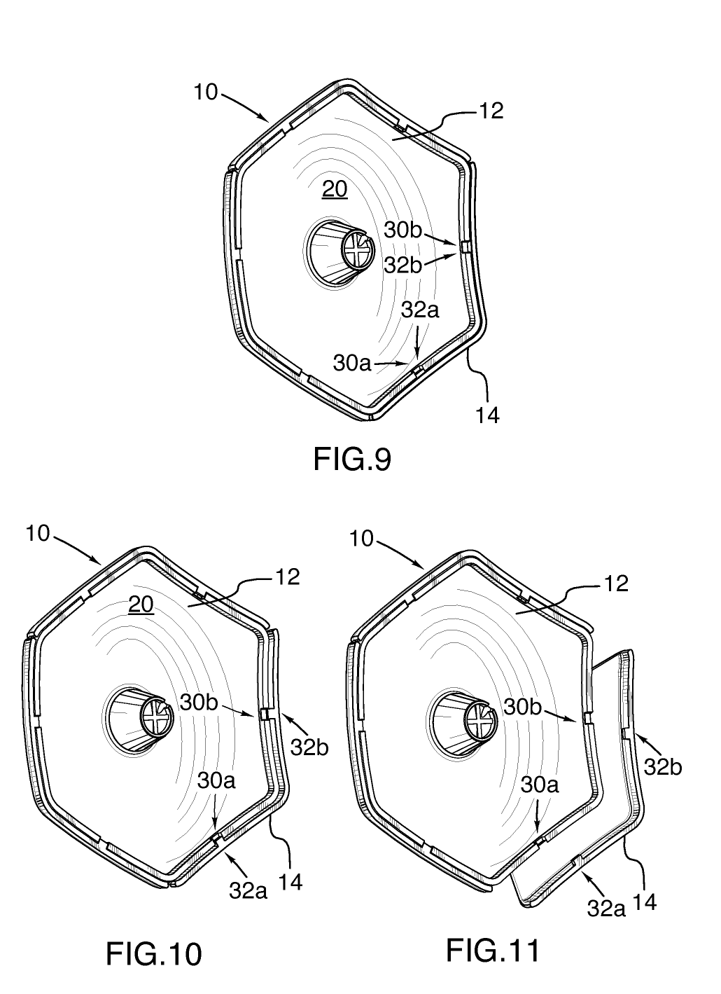

FIGS. 9-11 depict disengagement of a presentation element 14 from the base 12. For clarity, FIGS. 9-11 show the underside 20 of the base 12. In FIG. 9, the presentation element 14 is securely attached to the base 12. In particular, protrusions 32a and 32b are seated in notches 30a and 30b, respectively. In FIG. 10, protrusions 32a and 32b have been disengaged from notches 30a and 30b, and presentation element 14 is free to be removed, as shown in FIG. 11. A different presentation element (typically one depicting different aesthetic qualities) may now be attached to the base 12 at notch 30a or notch 30b or both.

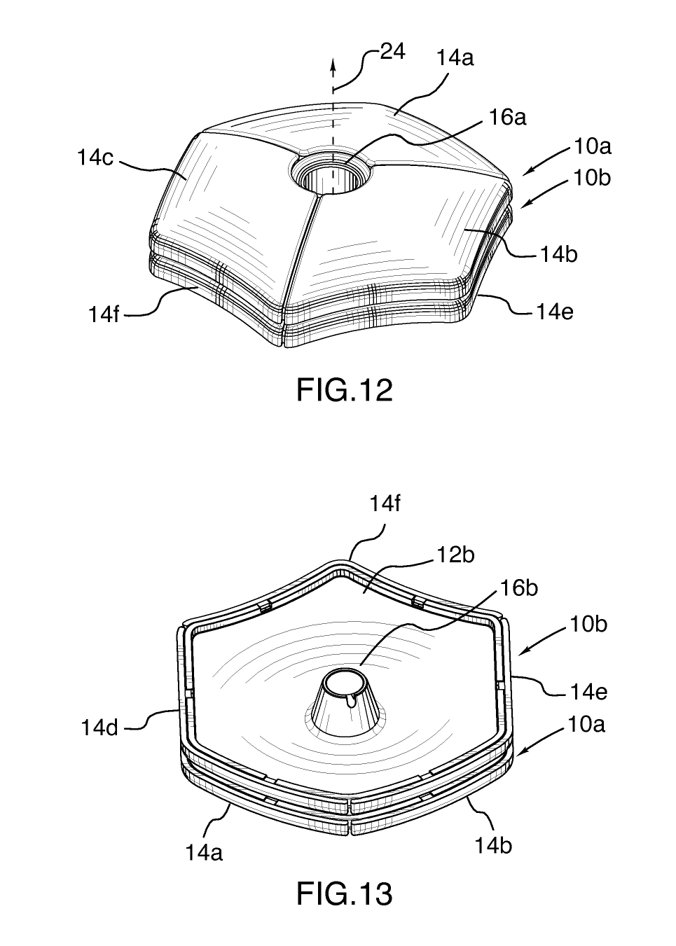

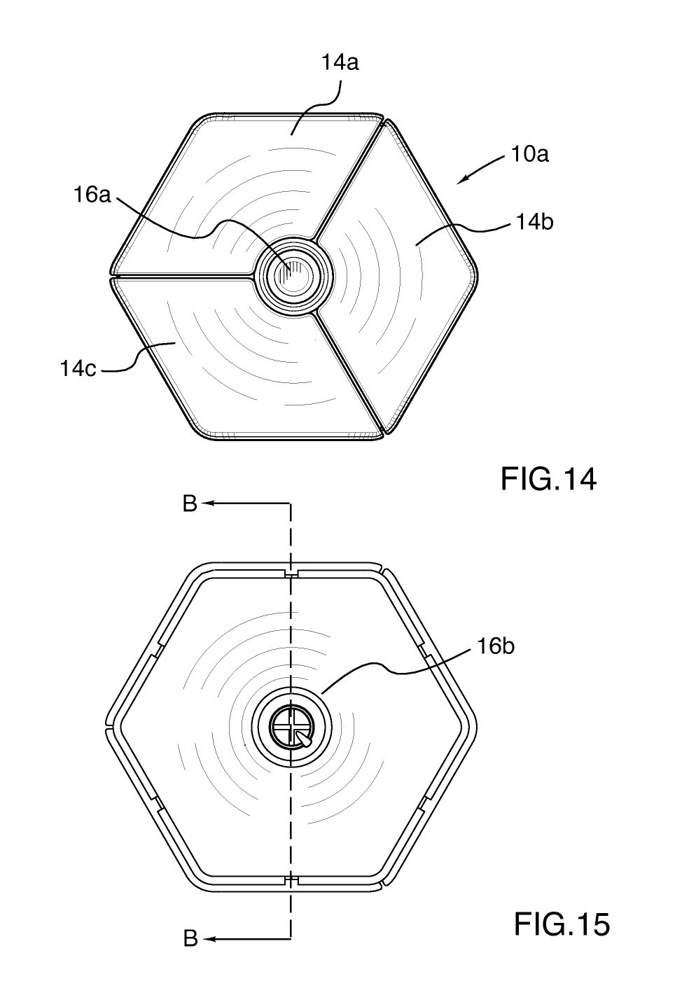

FIGS. 12 and 13 represent perspective views of two presentation tools 10a and 10b. FIGS. 14 and 15 represent top and bottom plan views of the presentation tools 10a and 10b. Each presentation tool 10a, 10b includes a set of attached presentation elements 14a-f. As shown in FIGS. 12 and 13, the presentation tools 10a and 10b can be stacked or nested. In particular, the well 16a of the presentation tool 10a can be nested inside the well 16b of the presentation tool 10b. Because the wells 16a-b are at least partly in the shape of a frustum, one well 16a can readily nest inside, yet be readily withdrawn from, another well 16b.

Viewed from overhead, as depicted in FIG. 14, the presentation tool 10a looks almost like a single presentation tool, with presentation tool 10b being barely visible. Similarly, when Viewed from below, as depicted in FIG. 15, the presentation tool 10a is barely visible. In other words, the presentation elements 10a and 10b are aligned with respect to their rotation around the reference axis 24. Although the presentation tools 10a and 10b may be rotated around the reference axis 24 such that both may be visible from overhead and below, the shape of the presentation elements 10a and 10b supports an easy alignment of the respective sides and vertices 28. As discussed above in relation to FIGS. 5-7, the vertices 28 may be substantially but the outer edges 22 of the bases 12 may bow upward. This bowing upward enables neater and more compact stacking or nesting of multiple presentation tools 10a and 10b.

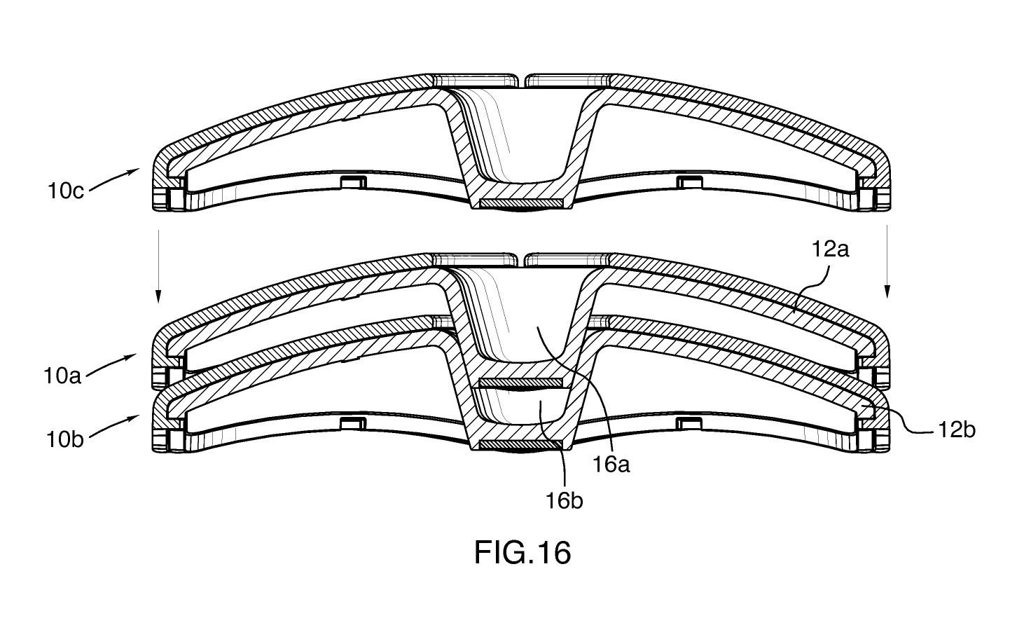

FIG. 16 is a cross-sectional view of the presentation tools 10a and 10b as cut by plane B-B (shown in FIG. 15) along the reference axis 24. As can be seen from FIG. 16, the presentation elements 10a and 10b nest together. The wells 16a and 16b nest such that the presentation tools 10a and 10b may be stacked without regard to whether or not there are presentation elements attached to any base 12a or 12b. Further, FIG. 16 shows that any number of presentation tools 10 may be so stacked. A third presentation tool 10c may be stacked onto presentation tools 10a and 10b. Stackability of presentation tools 10a-c may advantageous in a number of ways, such as improved portability and space-saving.

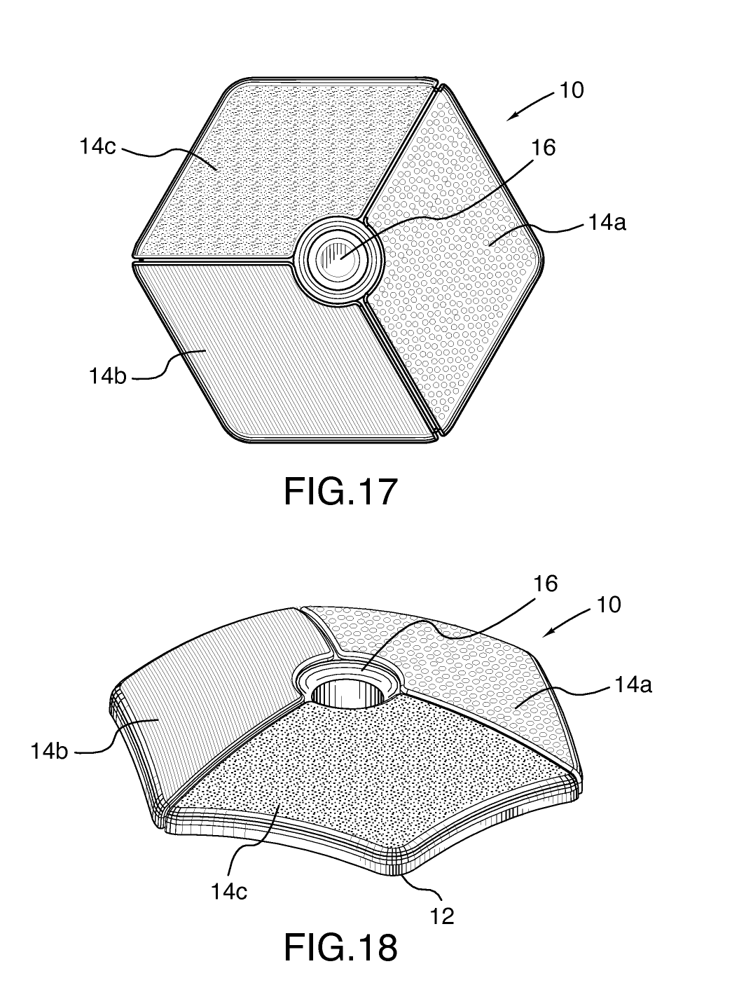

FIGS. 17 and 18 provide, respectively, an overhead plan view and a perspective view of a presentation tool 10 in a representative use. In FIGS. 17 and 18, each of presentation elements 14a-c present different aesthetic qualities, such as colours, surface textures and materials. Presentation elements 14a-c are simultaneously detachably connected to the base 12. With the aesthetic qualities presented in such a fashion, a person may evaluate different combinations of aesthetic qualities in relation to one another.

The aesthetic qualities that a presentation element 14 has may be made a part of the presentation element 14 in any of several ways. For example, a presentation element 14 that may be used to demonstrate a smooth, shiny, durable plastic of a particular colour may be molded from that plastic. In another example, a presentation element 14 that may be used to demonstrate a metallic trim may be molded from plastic and have the metallic trim bonded to it by adhesive, crimping, or other bonding technique. A single presentation element 14 may combine multiple aesthetic qualities. For example, a presentation element may include a faux leather having a first colour and texture with a ceramic trim element having a second colour and texture.

FIGS. 19 and 20 provide further illustration of a presentation tool 10 in a representative use. In FIG. 19, a presentation tool 10 includes a base 12 and three presentation elements 14a-c, with two presentation elements 14b and 14c attached to the base 12 and one presentation element 14a detached from the base 12. In FIG. 20, all three presentation elements 14a-c are detached from the base 12. Any presentation element 14 can be swapped for another presentation element having different aesthetic qualities. Aesthetic qualities can be mixed and matched in any order.

Although one or more embodiments have been shown and described in detail, the concepts are not limited to the particular embodiments that are shown. The shape of the base 12 and the presentation elements 14 may vary. The basic shapes of various presentation elements 14 need not be uniform, although uniformity may make storage and transport of the various presentation elements 14 easier. In some variations, a single base 12 may have attached several presentation elements of different sizes or shapes. The overall appearance of the presentation tool 10 need not be hexagonal (as previously mentioned), and more or fewer than three presentation elements 14 may be attached to a base 12 at any time.

One or more presentation element 14 need not be exactly as depicted above. It is not necessary that all presentation elements 14 have substantially the same overall shape. Further, although symmetry may be advantageous, the base 12 need not be symmetrical as shown, and the presentation elements 14 may be shaped to detachably connect to particular sites on the base 12. Further, it is not necessary that only the presentation elements 14 include one or more aesthetic qualities. It is also possible that the base 12 may include one or more aesthetic qualities. For example, the base 12 may be constructed of plain, shiny, rigid plastic, which has aesthetic qualities of its own. One or more presentation elements 14 may be detachably connected to the base 12 with a portion of the top side 18 of the base 12 being exposed.

Further, the base engagement 30 and the presentation element engagement 32 need not be exactly as depicted above. In one variation, the base engagement 30 may be a protrusion and the presentation element engagement 32 may be a notch. In other variations, the engagements may be other forms of snaps, hasps, grooves, ledges, and the like. The engagements need not be deployed proximate to the outer edge 22. In an illustrative variation, the top side 18 of the base 12 may include a base engagement 30 and the underside 38 of a presentation element 14 may include a presentation element engagement 32. For example, the top side 18 of the base 12 may include a base engagement 30 in the form of a “hook side” of a hook-and-loop fastener, and the underside 38 of a presentation element 14 may include a presentation element engagement 32 in the form of a “loop side” of a hook-and-loop fastener.

The above embodiments and variations may realize one or more potential advantages, some of which have been mentioned previously. One possible benefit that may be obtained is that multiple variations of aesthetic qualities of a product may be evaluated without actually undertaking the expense of building a product having those aesthetic qualities. Further, some of the embodiments enable rapid comparison of a variety of aesthetic qualities. As the number of presentation elements 14 increase, the number of potential combinations of aesthetic qualities increases even more rapidly. The ease of detachment of one presentation element 14 having one aesthetic quality, combined with the ease of replacement with a second presentation element 14 having a different aesthetic quality, can make the assessment of the aesthetic qualities more efficient and more pleasurable. Because the presentation elements 14 can be detachably connected to the base 12, the presentation tool 10 can be picked up and handled, and the aesthetic qualities can be observed and assessed, in virtually any desired way.

The shape of the presentation tool 10, and its various components, can enable ready transport. As already noted, some embodiments of the presentation tool 10 can be stacked, which can improve space-saving and can reduce shifting of components during transport. A presentation tool 10 that is substantially regularly hexagonal (as described previously) may be beneficial in that three or more such presentation tools may be “tiled” on planar surface with negligible gaps between them. In this way an even greater variety of aesthetic qualities can be assessed in combination at a single time.

The above embodiments are for illustration, and although one or more particular embodiments of the device and method have been described herein, changes and modifications may be made thereto without departing from the disclosure in its broadest aspects and as set forth in the following claims.

1. A device comprising:
a base (12), the base including at least one base engagement (30); and
at least one presentation element (14), the presentation element including at least one presentation element engagement (32);
wherein the base engagement (30) is configured to detachably connect to the presentation element engagement (32), and
wherein the presentation element includes at least one aesthetic quality.

2. The device of claim 1,
wherein the base includes a first base engagement and a second base engagement,
wherein the presentation element includes a first presentation element engagement and a second presentation element engagement, and
wherein the first base engagement is configured to detachably connect to the first presentation element engagement and the second base engagement is configured to detachably connect to the second presentation element engagement.

3. The device of claim 1,
wherein the base engagement comprises a notch and the presentation element engagement comprises a protrusion.

4. The device of claim 1,
wherein the base engagement is a first base engagement, the base including a second base engagement and a third base engagement;
wherein the presentation element is a first presentation element including a first presentation element engagement, the device further comprising a second presentation element including a second presentation element engagement and a third presentation element including a third presentation element engagement,
wherein the first base engagement is configured to detachably connect to the first presentation element engagement, and simultaneously the second base engagement is configured to detachably connect to the second presentation element engagement, and simultaneously the third base engagement is configured to detachably connect to the third presentation element engagement.

5. The device of claim 1,
wherein the base comprises an outer edge (22) having a perimeter, and a well (16) located at approximately the center of the perimeter of the outer edge.

6. The device of claim 5,
wherein the well is at least partly in the shape of a circular frustum.

7. The device of claim 1,
wherein the base comprises an outer edge (22) having at six vertices (28) that are substantially coplanar.

8. The device of claim 7,
wherein the vertices form a substantially regular hexagon.
